(19) United States
(12) Patent Application Publication
(10) Pub. No.: US 2006/0161591 A1
(43) Pub. Date: Jul. 20, 2006

(54) System and method for intelligent deletion of crawled documents from an index

(75) Inventors: Lin Huang, Redmond, WA (US); Dmitriy Meyerzon, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/036,412

(22) Filed: Jan. 14, 2005

(51) Int. Cl. G06F 17/30

(52) U.S. Cl. 707/200

(57) ABSTRACT

Documents are intelligently deleted from an index of crawled documents based on link and parent node information recorded from the crawl. A document visited during a first crawl may not be navigated to during a second crawl because of an error and the present invention verifies whether the document has been deleted. The present invention also prevents the document from being deleted when it is referenced by another document, indicating that the document is still a valid document.

### BACKGROUND OF THE INVENTION

Searches among networks and file systems for content have been provided in many forms but most commonly by a variant of a search engine. A search engine is a program that searches documents on a network for specified keywords and returns a list of the documents where the keywords were found. Often, the documents on the network are first identified by “crawling” the network.

Crawling the network refers to using a network crawling program, or a crawler, to identify the documents present on the network. A crawler is a computer program that automatically discovers and collects documents from one or more network locations while conducting a network crawl. The crawl begins by providing the crawler with a set of document addresses that act as seeds for the crawl and a set of crawl restriction rules that define the scope of the crawl. The crawler recursively gathers network addresses of linked documents referenced in the documents retrieved during the crawl. The crawler retrieves the document from a Web site, processes the received document data from the document and prepares the data to be subsequently processed by other programs. For example, a crawler may use the retrieved data to create an index of documents available over the Internet or an intranet. A “search engine” can later use the index to locate documents that satisfy specified criteria.

For retrieving documents in a crawl, an operation for each document on the network is executed to get the document and populate the index with records for the documents. A viable full text index system relies on a solid, reliable document gathering system that determines which documents (URLs) should be crawled, re-crawled or removed from the index. Previous designs do not consider link information or parent path information resulting in spurious deletion and rediscovery of the same documents in multiple crawls.

### SUMMARY OF THE INVENTION

Embodiments of the present invention are related to a system and method for intelligent deletion of documents from an index. Link and parent node information gathered during the crawl is used to determine whether an unvisited document recorded during a previous crawl should be removed. In accordance with one aspect of the present invention, if no valid path exists to the document, the document is removed from the index. As each crawl is commenced an incremental crawl number is recorded for each document along with each documents parent node and link information. Each document associated with an expired incremental crawl number is examined for its parent and link information. When the parent and link information indicates that no valid path exists for the document, it is removed from the index.

In accordance with once aspect of the present invention, a computer-implemented method is provided for determining whether to delete documents from an index. A determination is made whether a first type of error is associated with a previously crawled document. The previously crawled document is deleted from the index in response to the presence of a first type of error, and other non-deleted documents that are not referenced by other documents in the index are recursively deleted from the index.

In accordance with another aspect of the present invention, a system for determining whether to delete documents from an index includes a computing device arranged to manage an index of crawled documents. The computing device is configured to determine whether a first type of error is associated with a previously crawled document and delete the previously crawled document from the index in response to the presence of a first type of error. Additionally, the computing device recursively deletes other non-deleted documents from the index pointed to by the deleted previously crawled document that are not referenced by other documents in the index.

In accordance with still a further aspect of the present invention, a computer-readable medium includes computer-executable instructions for determining whether to delete documents from an index. The instructions include collecting link information for the documents during a crawl of the documents. The instructions determine whether a first type of error is associated with a previously crawled document and delete the previously crawled document from the index in response to the presence of a first type of error. Additionally, other non-deleted documents that are not referenced by other documents in the index are recursively deleted from the index pointed to by the deleted previously crawled document

### BRIEF DESCRIPTION OF THE DRAWINGS

FIG. 1 illustrates an exemplary computing device that may be used in one exemplary embodiment of the present invention.

FIG. 2 illustrates an exemplary link graph for a first and second crawl of a corpus of documents in accordance with the present invention.

FIG. 3 illustrates tables of link and parent node information in accordance with the present invention.

FIG. 4 illustrates and exemplary state diagram for intelligently deleting documents from an index in accordance with the present invention.

FIG. 5 illustrates a logical flow diagram of an exemplary process for intelligently deleting documents from an index in accordance with the present invention.

### DETAILED DESCRIPTION

The present invention now will be described more fully hereinafter with reference to the accompanying drawings, which form a part hereof, and which show, by way of illustration, specific exemplary embodiments for practicing the invention. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Illustrative Operating Environment

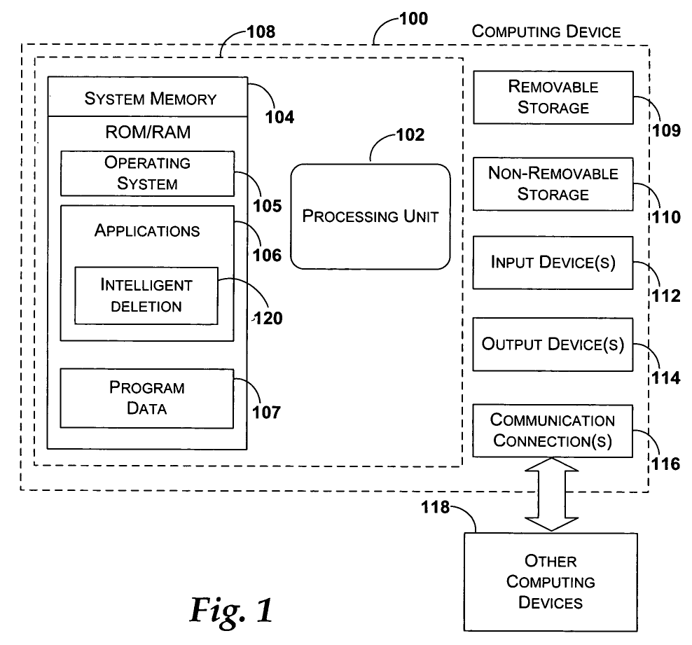

With reference to FIG. 1, one exemplary system for implementing the invention includes a computing device, such as computing device 100. Computing device 100 may be configured as a client, a server, mobile device, or any other computing device. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more applications 106, and may include program data 107. In one embodiment, application 106 includes an intelligent deletion application 120 for implementing the functionality of the present invention. This basic configuration is illustrated in FIG. 1 by those components within dashed line 108.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included.

Computing device 100 also contains communication connections 116 that allow the device to communicate with other computing devices 118, such as over a network. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Illustrative Embodiment for Intelligent Deletion of Documents

The present invention is related to intelligent deletion of documents from an index by examining link information for the documents. Throughout the following description and the claims, the term “document” refers to any possible resource that may be returned by as the result of a search query or crawl of a network, such as network documents, files, folders, web pages, and other resources.

Previously, deletion of documents was handled by associating each crawl with an incremental crawl number. Each document crawled within the system is stamped with this latest crawl number. After the crawl is complete, unvisited documents are identifiable by their expired crawl number. Those documents associated with an expired crawl number could then be removed from the system. However, this method of deleting documents resulted in a spurious deletion and re-discovery of the same document in multiple crawls.

The present invention uses a link graph and parent path information gathered during the crawl to make a better delete decision for those unvisited documents. Specifically, a determination is made whether any reference to the document is still valid. If there is a valid reference, then the document is kept even though document is unvisited during the crawl. If reference to the document is no longer valid, the document is safely removed from the index preventing spurious deletion and re-discovery of the same valid document in multiple crawls.

A document cannot be crawled or is not visited in latest crawl for various reasons. For example, the document is indeed removed from the target system and the path to the document is no longer valid. For this example, the document receives an error code during the crawl indicating that it does not exist, and should be removed from the index. In another example, the parent folder of a file folder no longer exists, resulting in the crawl not reaching a document contained within the folder. In this example, the document within the folder should be removed from the index. In still another example, a site manager may have updated all the pages of their site and removed all the links reference to a particular unvisited document. Without any references to the unvisited document, the document is no longer retrievable from the site, and the document should be removed from the index. In still another example, the unvisited document may still be valid; however, the references to the document have encountered errors. In one embodiment, a differentiation is made between the types of errors, where an error is considered “retry-able” or not. Errors considered retry-able are soft errors rather than hard errors that do not correspond to “access denied” errors or “file not found’ errors (e.g., a “time out” error is considered retry-able, where a document failed to get crawled because a time limit for rendering the document was reached). The present invention allows those documents unvisited due to retry-able errors to be retained in the index and prevent deletion of such valid documents.

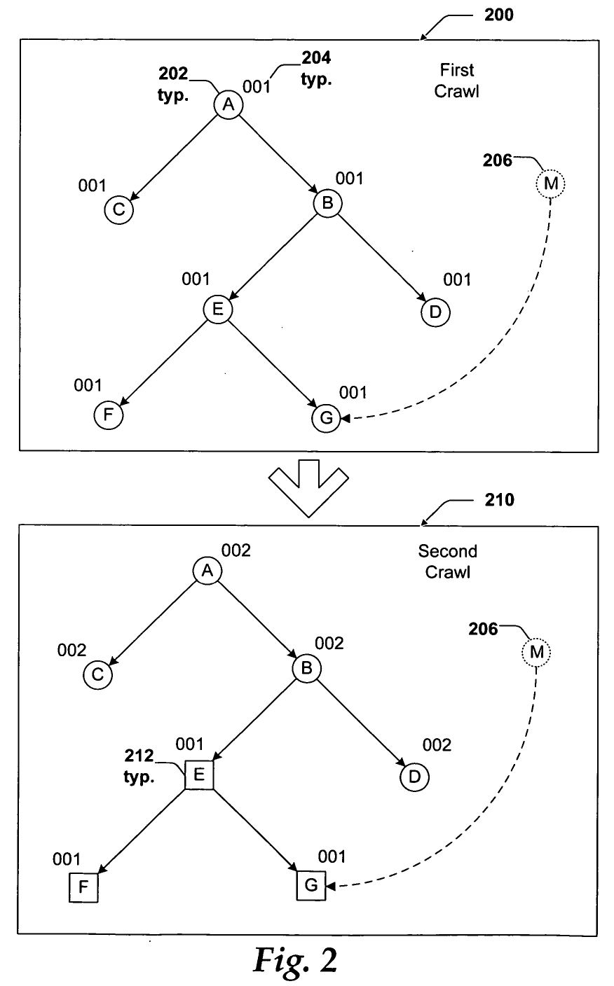

FIG. 2 illustrates an exemplary link graph for a first and second crawl of a corpus of documents in accordance with the present invention. Link graph 200 corresponds to the first crawl of the corpus of documents, and link graph 210 corresponds to the second crawl of the corpus of documents. Each link graph (e.g., 200) includes a number of nodes (e.g., 202), where each node corresponds to a document. Additionally, each node has a corresponding crawl number (e.g., 204).

The first and second crawls are similar except that documents E, F, and G correspond to documents (e.g., 212) that were not reached during the second crawl due to a hard error that occurred at document E. The crawl number associated with documents E, F, and G indicates that they were unvisited by the second crawl since they are still associated with the crawl number (e.g, 001) corresponding to the first crawl. Previously, documents E, F, and G would have been deleted from index due to the difference in crawl numbers. However, the present invention does not automatically delete these documents. Instead, the present invention is able to determine whether to keep the documents within the index based on their parent node or link information.

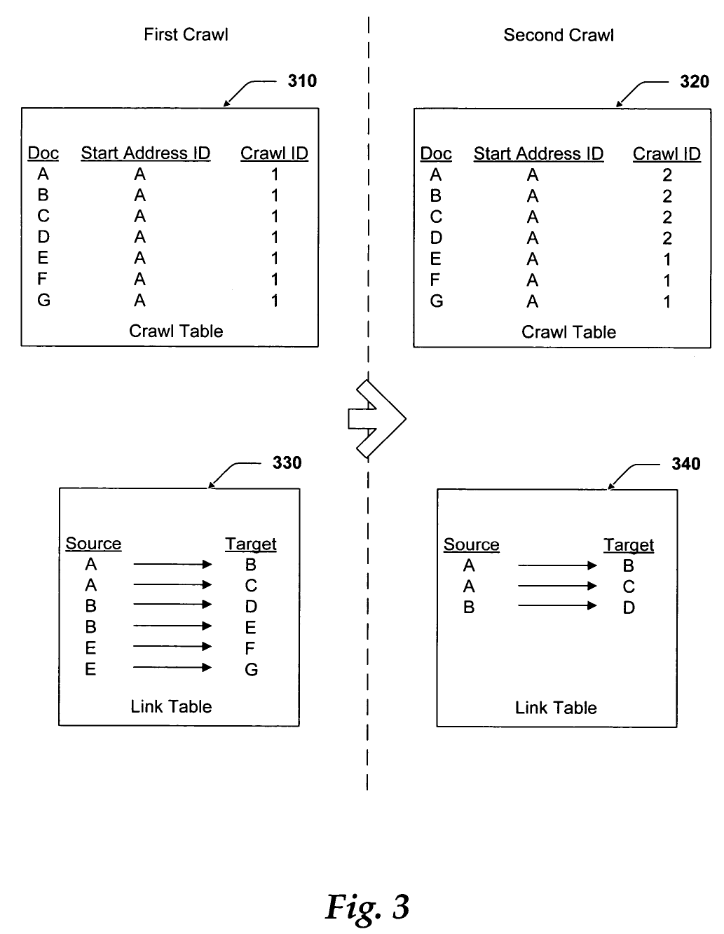

FIG. 3 illustrates tables of link and parent node information in accordance with the present invention. A crawl table (e.g., 310) and a link table (e.g., 330) are used to provide the link and parent node information for a particular crawl of a corpus of documents. Illustrated are the changes between a first crawl and a second crawl. The content included in tables 310 and 330 correspond to link graph 200 shown in FIG. 2, while the content included in tables 320 and 340 correspond to link graph 210.

As stated previously, each crawl has an associated crawl number. Each document is associated with the current crawl number in the crawl table (e.g., 310) after that document is crawled. Each crawl number is associated with a particular parent document. In the example shown, the first and second crawls originate from document A. Other crawls may originate at other documents and have their own associated crawl numbers. Since document E had an associated hard error in the scenario described in FIG. 2, documents E, F, and G are not associated with the most recent crawl number (002) for the crawl originating from document A. Instead, documents E. F, and G are still associated with the crawl number provided according to the first crawl (001). Accordingly, by examining the current state of the crawl table (e.g., 320), the indexing system is able to determine which documents were unvisited in the most recent crawl due to an error or other occurrence.

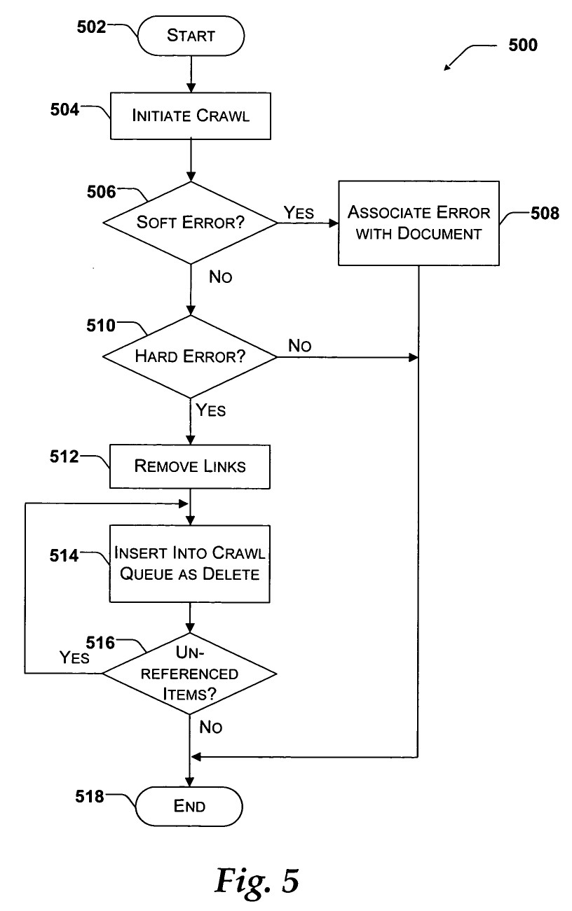

In a full crawl process (i.e., a complete crawl the whole corpus), the document crawl number may be identified to determine which documents have been crawled. Those documents without an updated crawl identifier be checked against the link table (e.g., 330) to see whether any documents are no longer referenced. When the documents are no longer referenced, they may be added to a crawl queue for deletion. Each time the crawl queue is emptied, those un-updated crawl number documents are reexamined until none remain to be added to the crawl queue for deletion. (see FIG. 5 below) However, in an incremental crawl environment, not every document need to be crawled (i.e., a selective corpus is crawled). In an incremental crawl, the present invention doesn't just examine the documents by their crawl number. Instead, whenever a document encounters a hard error, the links that the document generates (i.e., the links that the document points to) are removed and those documents referenced only by the document are place in the crawl queue for deletion.

Additionally, due to the hard error associated with document E, the links between documents E, F, and G are removed from links table 340 since these documents were unvisited. For these documents to be retained in the index, another link from a document to documents E, F, and G is required. For example, if a document M (206) were to have a reference to document G, document G would be retained in the index in accordance with the present invention. Document G would be retained even though document G was unvisited during the second crawl that originated from document A.

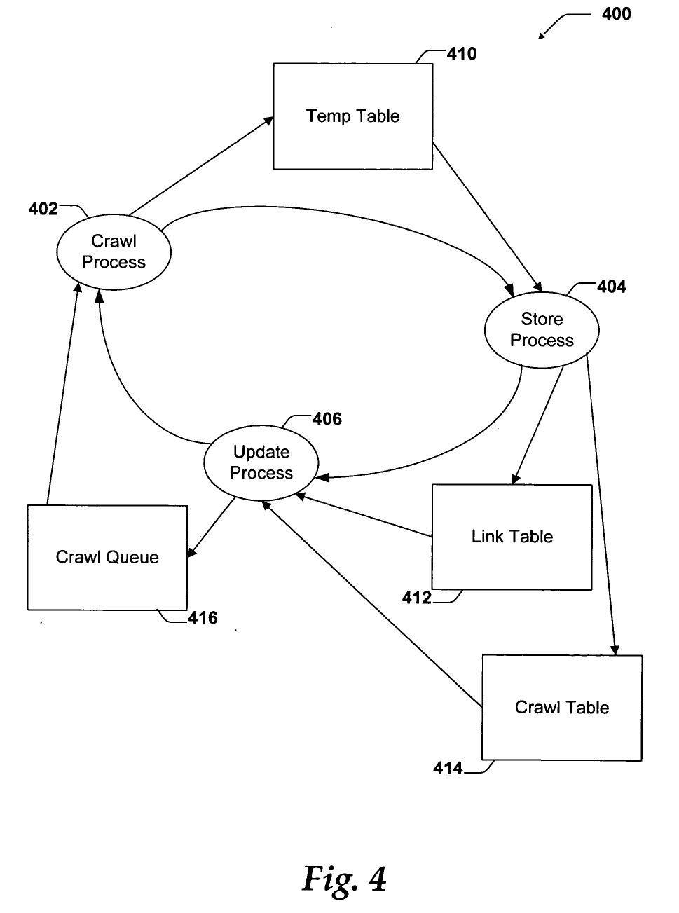

The crawl table (e.g., 320) and link table (e.g., 340) are used in the present invention to update a crawl queue (not shown) in a recursive process. The recursive process allows the present invention to delete a document and then repeat the process in light of the deletion. A more detailed description of the recursive process is described in the discussions of FIGS. 4 and 5 below.

FIG. 4 illustrates and exemplary state diagram for intelligently deleting documents from an index in accordance with the present invention. State diagram 400 includes three separate states corresponding to three separate processes that may be occurring with respect to an index. The processes include crawl process 402, store process 404, and update process 406.

Crawl process 402 corresponds to the initial crawl of a corpus of documents or an incremental crawl of the same corpus. An incremental crawl of documents may occur to retrieve updates and changes to the corpus of documents and may not correspond to a full crawl. In one embodiment, the portion of the corpus crawled corresponds to a listing of documents provided crawl queue 416. As crawl process 402 executes and the corpus is crawled, the information corresponding to the crawl is pushed to temp table 410. In one embodiment, temp table 410 represents a temporary storage of the data included in link table 412 and crawl table 414.

Store process 404 takes the data recorded from the crawl in temp table 410 and pushes it to link table 412 and crawl table 414. In one embodiment, link table 412 and crawl table 414 correspond to link table 330 and crawl table 310 shown in FIG. 3 respectively.

Update process 406 examines the data stored in link table 412 and crawl table 414 and determines which of the documents recorded in the index should be deleted since these documents were unvisited documents in a subsequent crawl. Update process 406 looks at the crawl number and makes sure there are no incoming links from existing documents. Update process 406 adds these documents to crawl queue 416 for deletion. As subsequent crawls occur, the data in link table 412 and crawl table 414 may indicate additional documents for deletion. When a document is deleted, other documents pointed to by that document may also need to be deleted. As these changes occur, update process 406 adds these documents to crawl queue 416 for deletion. In accordance with the present invention, those documents pointed to by another valid document on the index are saved from deletion. Crawl queue 416 may also include process requests that instruct another batch of the corpus to be crawled. When the deletion of the documents is complete and all batches have been crawled, the index is updated to reflect the current valid documents contained within the corpus.

In one embodiment, link table 412 and crawl table 414 are a single table. In an additional embodiment, link table 412 and crawl table 414 are separated into additional tables not shown. In a further embodiment, temp table 410 may be comprised of more than one table.

FIG. 5 illustrates a logical flow diagram of an exemplary process for intelligently deleting documents from an index in accordance with the present invention. Process 500 starts at block 502 where an initial crawl of the corpus has been made and the link and parent node information from the initial crawl has been recorded. Processing continues at block 504.

At block 504, a subsequent crawl is initiated. This crawl may correspond to a incremental crawl where the crawl is focusing on changes to documents since the previous crawl, or the crawl may correspond to a full second crawl of the corpus. Processing continues at decision block 506.

At decision block 506, while the subsequent crawl is executed, a determination is made whether a soft error has occurred with relation a document. A soft error may correspond to any error that does not indicate that the document in fact does not exist. If a soft error has occurred, processing moves to block 508.

At block 508, the error is associated with the document for reference and processing proceeds to block 518 where the crawl continues with the next document.

If a soft error has not occurred, a hard error may have occurred and processing moves to decision block 510.

At decision block 510, a determination is made whether a hard error is associated with the document. The hard error may be a “not found” error or some other type of error indicating that the document no longer exists. If no hard error has occurred, processing advances to block 518, where process 500 ends and the crawl continues with the next document.

In contrast, if a hard error has occurred, this information is included in information recorded from the crawl and processing continues at block 512.

At block 512, the link corresponding to the document is removed from the link table. Once the crawl is complete, the recorded information from the crawl is pushed to storage in the crawl table and link table as described in FIG. 4. If a document was unvisited due to a hard error, then the link to that documents, as well as the links from that document to other documents is removed from the link table. Processing continues at block 514.

At block 514, the document is inserted into the crawl queue as a document to be deleted from the index. Deleting this document may affect the status of other documents in the index. Processing continues at decision block 516.

At decision block 516, a determination is made whether other documents are included in the index that are no longer pointed to by another document. Since the document was deleted due to the error, other documents that were solely referenced by that document are no longer pointed to. Without a reference to these documents, they should be removed. If there are unreferenced items in the index, then processing returns to block 514 where these unreferenced items are added to the crawl queue to be deleted. However, if no more unreferenced items are included in the index, processing continues to block 518 where process 500 ends and other process with respect to the index may be initiated.

Throughout process 500, the crawl associated with executing the functionality of the present invention is in various stages of completion. It is understood that the process steps of the present invention operated at different intervals throughout the execution and after completion of a crawl. The above description of process 500 does not provide a description of the process steps required for crawling documents. Crawling of documents is well-known and is therefore not discussed in detail herein.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for determining whether to delete documents from an index, comprising:
determining whether a first type of error is associated with a previously crawled document;
deleting the previously crawled document from the index in response to the presence of a first type of error; and
recursively deleting other non-deleted documents from the index that are not referenced by other documents in the index.

2. The computer-implemented method of claim 1, further comprising collecting link information for the previously crawled document, wherein the link information is used to determine which documents are pointed to by the previously crawled document.

3. The computer-implemented method of claim 1, wherein the first type of error is a hard error.

4. The computer-implemented method of claim 2, wherein a hard error includes a file not found error, and an access denied error.

5. The computer-implemented method of claim 1, wherein a crawl number is associated with the previously crawled document, wherein the crawl number corresponds to a particular crawl.

6. The computer-implemented method of claim 5, wherein the previously crawled document is deemed to have an associated first type of error when the crawl number associated with the crawled document does not correspond to a current crawl.

7. The computer-implemented method of claim 1, further comprising determining whether the previously crawled document is associated with a second type of error.

8. The computer-implemented method of claim 7, wherein the second type of error is a soft error.

9. The computer-implemented method of claim 7, wherein the previously crawled document is not deleted when the previously crawled document is associated with the second type of error.

10. A system for determining whether to delete documents from an index, comprising:
a computing device arranged to manage an index of crawled documents, the computing device configured to execute computer-executable instructions, the computer-executable instructions comprising:
determining whether a first type of error is associated with a previously crawled document;
deleting the previously crawled document from the index in response to the presence of a first type of error; and
recursively deleting other non-deleted documents from the index pointed to by the deleted previously crawled document that are not referenced by other documents in the index.

11. The system of claim 10, further comprising collecting link information for the previously crawled document, wherein the link information is used to determine which documents are pointed to by the previously crawled document.

12. The system of claim 10, wherein the first type of error is a hard error.

13. The system of claim 12, wherein a hard error includes a file not found error, and an access denied error.

14. The system of claim 10, wherein a crawl number corresponding to particular crawl is associated with the previously crawled document such that the previously crawled document is deemed to have an associated first type of error when the crawl number associated with the crawled document does not correspond to a current crawl.

15. The system of claim 10, further comprising determining whether the previously crawled document is associated with a second type of error wherein the second type of error is a soft error and the previously crawled document is not deleted when the previously crawled document is associated with the second type of error.

16. A computer-readable medium that includes computer-executable instructions for determining whether to delete documents from an index, the instructions comprising:
Collecting link information for the documents during a crawl of the documents;
determining whether a first type of error is associated with a previously crawled document;
deleting the previously crawled document from the index in response to the presence of a first type of error; and
recursively deleting other non-deleted documents from the index pointed to by the deleted previously crawled document that are not referenced by other documents in the index.

17. The computer-readable medium of claim 16, wherein the first type of error is a hard error.

18. The computer-readable medium of claim 17, wherein a hard error includes a file not found error, and an access denied error.

19. The computer-readable medium of claim 16, wherein a crawl number corresponding to particular crawl is associated with the previously crawled document such that the previously crawled document is deemed to have an associated first type of error when the crawl number associated with the crawled document does not correspond to a current crawl.

20. The computer-readable medium of claim 16, further comprising determining whether the previously crawled document is associated with a second type of error wherein the second type of error is a soft error and the previously crawled document is not deleted when the previously crawled document is associated with the second type of error.
